(19) United States
(12) Patent Application Publication
(10) Pub. No.: US 2017/0061502 A1
(43) Pub. Date: Mar. 2, 2017

(54) UNIFIED CROSS-CHANNEL ADVERTISEMENT PLATFORM

(71) Applicant: eBay Inc., San Jose, CA (US)

(72) Inventors: Jian Zhang, Bellevue, WA (US); Matthias Klappenbach, Seattle, WA (US); Sang-Hun Kim, Issaquah, WA (US)

(21) Appl. No.: 14/861,884

(22) Filed: Sep. 22, 2015

Related U.S. Application Data
(60) Provisional application No. 62/212,478, filed on Aug. 31, 2015.

(51) Int. Cl. G06Q 30/02

(52) U.S. Cl. CPC G06Q 30/0275; G06Q 30/0256; G06Q 30/0277

(57) ABSTRACT

A system comprising a computer-readable storage medium storing at least one program and a computer-implemented method for facilitating unified cross-channel advertisement are presented, including a method of generating a bidding value for an advertisement opportunity that is useable across a plurality of advertisement channels. In one embodiment, the method includes accessing an item data record cluster and an audience cluster, assigning the item data record cluster and audience cluster to a bidding value table, assigning a bidding unit to a combination of the item data record cluster and the audience cluster, the combination of the item data record cluster and the audience cluster being among a plurality of combinations of item data record clusters and audience clusters in the bidding value table, and generating a bidding value for the bidding unit, the bidding value including an amount of value to be paid for an advertisement opportunity for the bidding unit.

### PRIORITY

This application is a Non-Provisional of and claims the benefit of priority under 35 U.S.C. §119(e) from U.S. Provisional Application Ser. No. 62/212,478, entitled “UNIFIED CROSS-CHANNEL ADVERTISEMENT PLATFORM,” filed on Aug. 31, 2015 which is hereby incorporated by reference herein in its entirety.

### TECHNICAL FIELD

The subject matter disclosed herein generally relates to the technical field of special-purpose machines that facilitate data processing, including computerized variants of such special-purpose machines and improvements thereto. Specifically, the present disclosure is directed to a unified cross-channel platform.

### BACKGROUND

Advertisement is a critical part of many online businesses. The rise in advertisement technology and social media provide opportunities for advertisers to reach broader audiences in a focused manner by presenting ads to users of online search engines and social media constructs based on their unique preferences, demographic data, and history of online purchases. One challenge in building online advertising campaigns is that an advertising campaign for a particular advertising channel may take years and tens of millions of dollars to develop.

### BRIEF DESCRIPTION OF THE DRAWINGS

Some embodiments are illustrated by way of example and not limitation in the figures of the accompanying drawings.

FIG. 1 is a network diagram illustrating a network environment suitable for facilitating a unified cross-channel advertisement platform, according to some example embodiments.

FIG. 2 is a block diagram illustrating functional components of the unified cross-channel advertisement management platform, according to some example embodiments.

FIG. 3 is a diagram illustrating a portion of a bidding value table, according to some example embodiments.

FIG. 4 is a flowchart illustrating operations of a device in performing a method for generating bidding values, according to some example embodiments.

FIG. 5 is a block diagram illustrating components of a machine, according to some example embodiments, able to read instructions from a machine-readable medium and perform any one or more of the methodologies discussed herein.

### DETAILED DESCRIPTION

Reference will now be made in detail to specific example embodiments for carrying out the inventive subject matter. Examples of these specific embodiments are illustrated in the accompanying drawings. It will be understood that these examples are not intended to limit the scope of the claims to the illustrated embodiments. On the contrary, they are intended to cover alternatives, modifications, and equivalents as may be included within the scope of the disclosure. In the following description, specific details are set forth in order to provide a thorough understanding of the subject matter. Embodiments may be practiced without some or all of these specific details.

Example embodiments described herein facilitate unified cross-channel advertisement, in part, by a combination of back-end processing for a first advertisement channel (e.g., for an online search engine advertisement channel) with processing for a second advertisement channel (e.g., for an online social advertisement channel), or any subsequent channels, into a common engineering infrastructure. As described herein, an Unified Cross-Channel Advertisement Management Platform (UCAMP) architecture is utilized across advertisement channels, given a set of item data records (e.g, item listings) and a set of user identifiers. The UCAMP is scalable and is capable of managing advertising channels involving pluralities of different types of user identifiers and item data records.

An advertisement channel may include an online search engine environment (e.g., Google AdWords®) that displays advertisements to users of the search engine according to information pertaining to the user and search terms the user enters for a search. An advertiser wanting to bid for an advertising opportunity within the online search engine environment may create, for example, a remarketing list for search ads (RLSA). An RLSA is one tool that allows the advertiser to customize a search ad campaign for users of the advertiser's website that have previously visited that advertiser's website. RLSAs allow the advertiser to create and adjust bids for an opportunity to advertise to a particular user when the user is subsequently searching on the online search engine environment. Therefore, the RLSA may help the advertiser reconnect with a user that, for example, has visited the advertiser's website and did not make a purchase. In creating the RLSA with knowledge of a particular type of user or groups of users comprising a particular user audience, the advertiser may set a bidding value that it is willing to pay for an advertising opportunity to the particular user audience, create the advertisements, and select keywords that are specific to the user audience.

Additionally, the advertiser may bid on keywords that it does not normally bid on or may optimize bids for existing keywords based on a type of user that has recently visited the advertiser's website or that has made a purchase from the advertiser in the past. For example, the advertiser may increase a bid for an advertising opportunity by 25% for users that have previously viewed the advertiser's website within the last 30 days. As another example, the advertiser may choose to bid on and show a different advertisement to users who have placed items into an online shopping cart on an advertiser's website but did not follow through with a purchase.

In example embodiments, a search engine advertisement platform requests the advertiser to specify an audience cluster. The audience cluster may include a group of user identifiers representing users that each share a common trait (e.g., keywords used in an online search, time of day that the user is searching, geographical location, and language). The advertisement channel (e.g., social advertisement channel) may also include an internet-based social interactive construct (e.g., Facebook®) that displays advertisements to users of the social interactive construct according to information known about the users. Using the internet-based social interactive construct, the advertiser targets their ads to a specific set of users that have recently visited the advertiser's website, that have made a purchase from the advertiser in the past, or otherwise have an established relationship with the advertiser.

A social advertisement platform may also request the advertiser to specify the audience cluster, for example, a group of user identifiers representing users that each share a common trait (e.g., age, gender, geographical location, language, users that have searched certain types of websites). Additionally, audience clusters may be defined by, for example, email address, user ID, phone numbers, or Mobile Advertiser ID. Within the UCAMP, all user identifiers within the audience cluster are handled in the same way in terms of bidding. Therefore, if a bid is based on a particular user identifier trait that more than one user identifiers share, those user identifiers may all be within the same audience cluster.

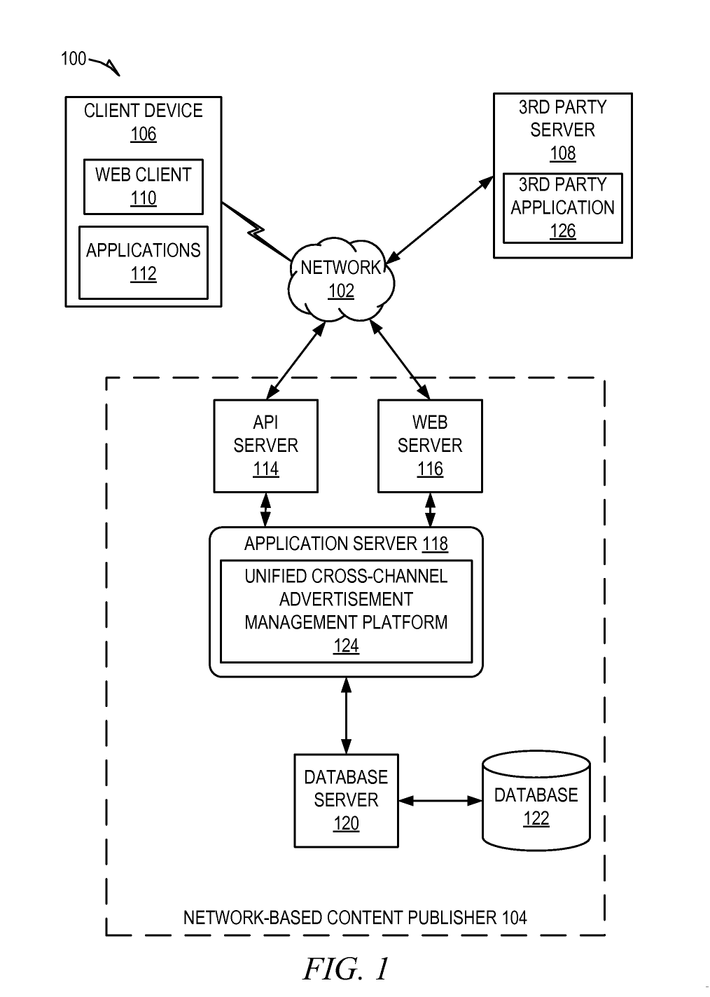

FIG. 1 is a network diagram illustrating a network system 100 suitable for facilitating a UCAMP, according to one embodiment, having a client-server architecture configured for exchanging data over a network 102. While the network system 100 is depicted as having a client-server architecture, the present inventive subject matter is, of course, not limited to such an architecture, and could equally well find application in an event-driven, distributed, or peer-to-peer architecture system, for example. Further, to avoid obscuring the inventive subject matter with unnecessary detail, various functional components that are not germane to conveying an understanding of the inventive subject matter have been omitted from FIG. 1. Moreover, it shall be appreciated that although the various functional components of the network system 100 are discussed in the singular sense, multiple instances of any one of the various functional components may be employed.

The network system 100 includes a network-based content publisher 104 in communication with a client device 106 and a third party server 108. In some example embodiments, the network-based content publisher 104 may be a network-based marketplace (e.g., eBay.com). The network-based content publisher 104 communicates and exchanges data within the network system 100 that pertain to various functions and aspects associated with the network system 100 and its users. The network-based content publisher 104 may provide server-side functionality, via a network 102 (e.g., the Internet), to network devices such as the client device 106.

The client device 106 may be operated by users who use the network system 100 to exchange data over the network 102. These data exchanges include transmitting, receiving (communicating), and processing data to, from, and regarding content and users of the network system 100. The data may include, but are not limited to, images; video or audio content; user preferences; product and service feedback, advice, and reviews; product, service, manufacturer, and vendor recommendations and identifiers; product and service listings associated with buyers and sellers; product and service advertisements; auction bids; transaction data; user profile data; and social data, among other things.

The client device 106 may interface with the network-based content publisher 104 via a connection with the network 102. Depending on the form of the client device 106, any of a variety of types of connections and networks 102 may be used. For example, the connection may be Code Division Multiple Access (CDMA) connection, a Global System for Mobile communications (GSM) connection, or another type of cellular connection. Such a connection may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks). When such technology is employed, the network 102 may include a cellular network that has a plurality of cell sites of overlapping geographic coverage, interconnected by cellular telephone exchanges. These cellular telephone exchanges may be coupled to a network backbone (e.g., the public switched telephone network (PSTN), a packet-switched data network, or other types of networks).

In another example, the connection to the network 102 may be a Wireless Fidelity (Wi-Fi, IEEE 802.11x type) connection, a Worldwide Interoperability for Microwave Access (WiMAX) connection, or another type of wireless data connection. In such an embodiment, the network 102 may include one or more wireless access points coupled to a local area network (LAN), a wide area network (WAN), the Internet, or another packet-switched data network. In yet another example, the connection to the network 102 may be a wired connection (e.g., an Ethernet link), and the network 102 may be a LAN, a WAN, the Internet, or another packet-switched data network. Accordingly, a variety of different configurations are expressly contemplated.

In various embodiments, the data exchanged within the network system 100 may be dependent upon user-selected functions available through one or more client or user interfaces (UIs). The UIs may be associated with a client device, such as the client device 106 executing a web client 110 (e.g., an Internet browser), which may be in communication with the network-based content publisher 104. The UIs may also be associated with one or more applications 112 executing on the client device 106, such as a mobile application designed for interacting with the network-based content publisher 104 or with a social network platform hosted by the third party server 108.

Turning specifically to the network-based content publisher 104, an API server 114 and a web server 116 are coupled to, and provide programmatic and web interfaces respectively to, an application server 118. As illustrated in FIG. 1, the application server 118 may be coupled via the API server 114 and the web server 116 to the network 102, for example, via wired or wireless interfaces. The application server 118 is, in turn, shown to be coupled to a database server 120 that facilitates access to a database 122. In some examples, the application server 118 can access the database 122 directly without the need for the database server 120. The database 122 may include multiple databases that may be internal or external to the network-based content publisher 104.

The application server 118 may, for example, host one or more applications, which provide a number of content publishing and viewing functions and services to users who access the network-based content publisher 104. For example, the network-based content publisher 104 may host a marketplace application that provides a number of marketplace functions and services to users, such as publishing, listing, and price-setting mechanisms whereby a seller may list (or publish information concerning) goods or services (also collectively referred to as “products”) for sale, a buyer can express interest in or indicate a desire to purchase such goods or services, and a price can be set for a transaction pertaining to the goods or services.

As illustrated in FIG. 1, the application server 118 hosts the UCAMP 124 that provides bids for advertising opportunities that can be used for a plurality of advertising channels. The bids may be utilized by the network-based content publisher 104 to display content (e.g., advertisements) to users of the network-based content publisher 104. The UCAMP 124 may provide bids based on information known about a user of the network-based content publisher 104 (e.g., keywords the user has used in an internet search, geographical location of user, and language of user). In some embodiments, the UCAMP 124 generates a plurality of bids for an audience cluster of the network-based content publisher 104. Each bid of the plurality of bids may be generated based on one of a plurality of content groups (e.g., item data record clusters), and the bid for a single user or a single group of users may change according to the content group used in generating the bid.

The messages generated and published by the UCAMP 124 may also include a reference to content (e.g., a link). As used herein, the terms “content” or “content item” refer to electronic data that is consumed by viewers (e.g., users) on displays, client devices, or page/display-based media (e.g., World-Wide Web (WWW) media embodied in browsers and accessible over the Internet). As such, the terms “content” and “content item” may refer to data associated with readable text, data associated with images, data associate with graphics or video, programmatic content, scripts, or data corresponding to various combinations of these. Further, while the UCAMP 124 is shown in FIG. 1 to form part of the network-based content publisher 104, it will be appreciated that, in alternative embodiments, the UCAMP 124 may form part of a service that is separate and distinct from the network-based content publisher 104.

The database 122 stores data pertaining to various functions and aspects associated with the network system 100 and its users. For example, the database 122 stores and maintains user profiles for users of the network-based content publisher 104. Each user profile comprises user profile data that describes aspects of a particular user. The user profile data may, for example, include demographic data, user preferences, social data, and financial information. The demographic data may, for example, include information describing one or more characteristics of a user such as gender, age, location information (e.g., hometown or current location), employment history, education history, contact information, familial relations, or user interests. The financial information may, for example, include private financial information of the user such as account number, credential, password, device identifier, user name, phone number, credit card information, bank information, transaction history, or other financial information which may be used to facilitate online transactions by the user.

The database 122 also stores a record of user activity. Accordingly, the network-based content publisher 104 may monitor, track, and record activities of users utilizing one or more devices (e.g., the client device 106) to interact with the various components of the network system 100 during a user session. Each user session may be maintained in a repository stored in the database 122. Accordingly, the user activity data may include past keyword searches that users have performed, web pages viewed by each user, products added to a user wish list or watch list, products added to an electronic shopping cart, and products that the users own. Consistent with some embodiments, the record of user activity is linked to user profile data so as to maintain an association of a user profile with the activities that the corresponding user has performed.

In instances in which the network-based content publisher 104 is a network-based marketplace, the database 122 stores product information. Such product information may, for example, include a product identifier (e.g., a title or a model number), a price, a make, a manufacturer, a model, a brand name, a textual description, a size, a style, product dimensions, compatibility information, or any other information that may be used to describe a product. In these instances, the database 122 may also store a transaction history of users of the network-based content publisher 104 that includes information related to transactions for products that may be offered for sale by merchants who utilize marketplace services provided by the network-based content publisher 104. The transaction history information may, for example, include a description of a product offered for sale, sold, or purchased by users, an identifier of the product, a category to which the product belongs, a purchase price, a purchase date, a purchased quantity, a number of bids for the product, or various combinations thereof.

FIG. 1 also illustrates a third party application 126 executing on the third party server 108 that may offer information or services to the application server 118 or to users of the client device 106. The third party application 126 has programmatic access to the network-based content publisher 104 via a programmatic interface provided by the API server 114. The third party application 126 is associated with any organization that may conduct transactions with or provide services to the application server 118 or to users of the client device 106. For example, the third party application 126 may be associated with a network based social network platform (e.g., Facebook®, Twitter®, Google+®, Pinterest®, LinkedIn®, or the like) that may provide a platform for members to build and maintain social networks and relations among members.

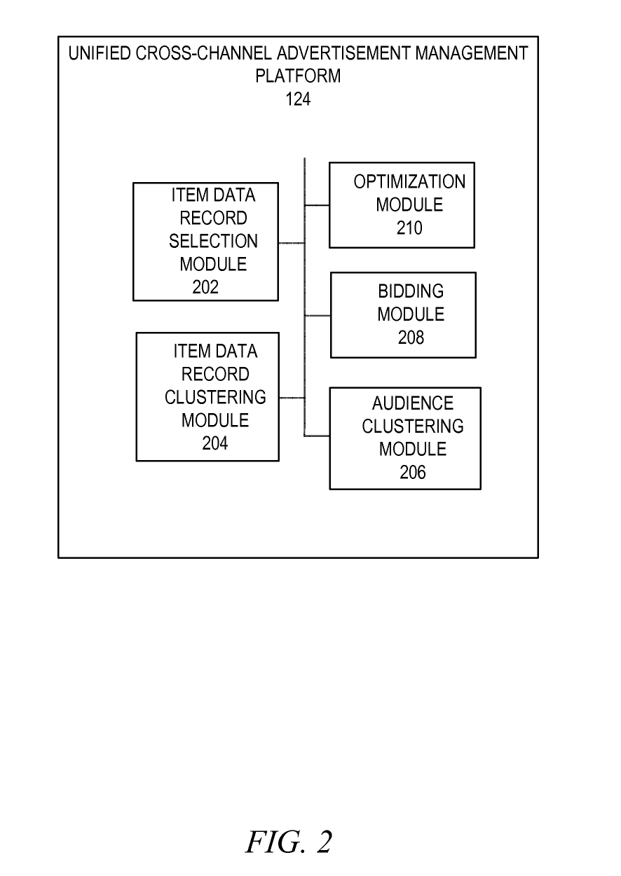

FIG. 2 is a block diagram illustrating functional components of the unified cross-channel advertisement management platforms (UCAMP) 124, according to some example embodiments. Various functional modules are shown for the UCAMP 124, which is provided as part of the network system 100, consistent with some embodiments. The UCAMP 124 is shown as including an item data record selection module 202, an item data record clustering module 204, an audience clustering module 206, a bidding module 208, and an optimization module 210, all configured to communicate with each other (e.g., via a bus, shared memory, a switch, or application programming interfaces (APIs)). The various modules of the UCAMP 124 may, furthermore, access the databases 122 via the database servers 120, and each of the various modules of the UCAMP 124 may be in communication with one or more of the third party applications 126 (e.g., a social network platform). Further, while the modules of FIG. 2 are discussed in the singular sense, it will be appreciated that in other embodiments multiple modules may be employed.

The item data record selection module 202 is responsible for receiving (e.g., accessing) content (e.g., an item data record) and determining whether to select the content for an advertising bid. In one embodiment, the item data record selection module 202 accesses a plurality of item data records from a data storage device (e.g., from the database 122) and selects an item data record to advertise on an advertisement channel (e.g., a search engine advertisement channel or a social advertisement channel). In certain embodiments, the item data record selection module 202 may select an item data record to advertise on another advertisement channel, not including a search engine advertisement channel or an internet-based social interactive construct advertisement channel.

In certain embodiments, the item data record selection module 202 may select an item data record to advertise according to a parameter of the item data record (e.g., a “click value score”). A search engine advertisement platform or a social advertisement platform may display content (e.g., an advertisement) to a user (e.g., user of the search engine or the internet-based social interactive construct, respectively) and may charge an advertiser an amount of value according to the number of times the user clicks on the displayed advertisement. The advertiser may specify an amount of value it is willing to pay for the search engine advertisement platform or the social advertisement platform to display the advertisement and may refer to this value as a click value score. A click value score may be determined from a calculated score that takes into account predicted item conversion rates and item prices. For example, a click value score may be calculated using the equation:

log(predicted conversion rules*(New price))*

where ∝ is a value between 0 and 1 and has different values dependent on a location (e.g., a location of the user that is clicking on the displayed advertisement). The conversion rate may represent a percentage of users that take a desired action (e.g., a percentage of users that make a purchase from the advertiser's website). Calculated click value scores may be updated with received market feedback data (e.g., data received from a search engine advertisement platform) that is related to past performance of a previously generated advertisement.

The item data record clustering module 204 accepts an item data record and places the item data record into an item data record cluster according to certain values (e.g., according to an item data record's click value score). In one embodiment, all of the item data records within an item data record cluster will be treated the same in terms of bidding for an advertising opportunity. Therefore, an item data record cluster may include a plurality of item data records that each share a common value. For example, each item data record within the item data record cluster shares the same click value score or has a click value score within a specified range (e.g., $0.25-$0.30 per click).

The audience clustering module 206 is responsible for receiving (e.g., accessing) a user identifier and generating an audience cluster that includes the user identifier (e.g., assigning the user identifier to an audience cluster). The audience clustering module 206 may access a user identifier from a data storage device (e.g., from the database 122). In one embodiment, the UCAMP 124 utilizes a “cookie sync” system. For example, when a user identifier (e.g., representing a user of an advertiser's website) visits the advertiser's website, depending on certain user identifier properties (e.g., keywords used to search for an item data record, geographical location, and language), the UCAMP 124 assigns the user identifier to an audience cluster. In one embodiment, the audience clustering module 206 receives a user identifier and generates an audience cluster that includes the user identifier. The user associated with the user identifier may receive a third party “cookie” on a user device (e.g., a “cookie sync”). The cookie identifies the user identifier's associated audience cluster information as a parameter. The UCAMP 124 may perform the cookie sync or a module outside of the UCAMP 124 may perform the cookie sync. The cookie used for a search engine advertisement channel may differ from the cookie used for a social advertisement channel.

In one embodiment, the UCAMP 124 assigns a user identifier to a particular audience cluster based on the mapping of the user identifier to an item data record. In embodiments involving a social advertisement channel, the UCAMP 124 may recommend the item data record for the user identifier concurrently with a cookie sync taking place. In embodiments involving the search engine advertisement channel, the UCAMP 124 may recommend the item data record for the user identifier concurrently with a user associated with the user identifier entering a search term into a search engine.

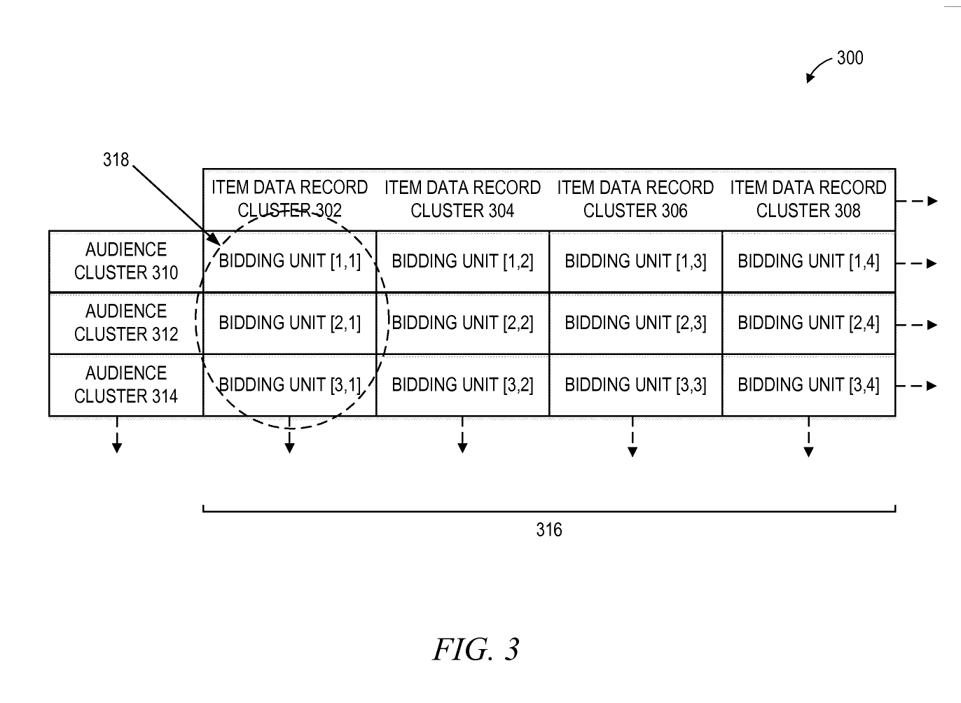

The bidding module 208 generates and maintains a bidding value table, which is stored in the database 122. A bidding value table contains cells of data values, referred to as “bidding units,” that represent intersections of item data record clusters and audience clusters. Further details of the bidding value table are discussed below in reference to FIG. 3, according to some example embodiments. The bidding module 208 may create a bidding value based on any one bidding unit. The bidding module 208 may create an output (e.g., a bidding value), including an amount of value that is to be paid for an advertising opportunity for a particular combination of item data record clusters and audience clusters (e.g., using a click value score). The UCAMP 124 may provide the bidding value to one or more advertising platforms (e.g., one or more social advertisement platforms, search engine advertisement platforms), in any combination.

In one embodiment, grouping item data records together allows historical data to be gathered for determining an average value of a click value score for a particular item data record within an item data record cluster. The optimization module 210 assists in the management of the UCAMP 124 by, for example, characterizing item data record clusters by click value scores, which may improve scalability and efficiency across advertisement channels.

A strategy for optimizing bidding values using the optimization module 210 includes, for example: (1) predicting a conversion rate of a particular item data record based on a range of data gathered from users visiting an advertiser's website and from historical performance data of previously generated advertisements, (2) calculating a click value score for each of the item data records, the score being closely correlated to revenue per click data, (3) grouping all of the item data records with similar scores together into a group that is large enough to generate a number of clicks that will provide an accurate average click value for the group, (4) receiving market data related to the performance of advertisements for a certain group of the item data records, and (5) bidding for an advertisement opportunity in accordance with the received market information and the advertiser's budget limitations.

In some embodiments, the optimization module 210 aggregates market data related to the performance of advertisements for a certain group of item data records as well as data gathered from a user visiting an advertiser's website. The aggregated data on this level may then be used to train a machine learning model to predict a conversion rate for a particular item data record. Data from the machine learning model may be applied at a certain frequency (e.g., on a daily basis) to a live item data record in order to generate group and bid information. Then using market feedback related to the live item data record (e.g., from Google AdWords®), the bid may be subsequently adjusted for the next day. The machine learning model may use a range of categories of data to predict a conversion rate. For example, the categories comprise an overall cost of an item represented by an item data record, a category used by an advertiser's website to organize an item data record, past financial performance of an item data record in production listing advertisements by an advertiser, statistical data regarding an item (e.g., impression, click, conversion, item “watch list,” and “add to list” tools, length of time an item is listed for sale on a website), statistical data of all items similar to another item in terms of title and description, and an item seller's statistics (e.g., rating by other users of the website, feedback, level of seller's experience).

FIG. 3 is a diagram illustrating a portion of a bidding value table 300, according to some example embodiments. The bidding value table 300 includes a plurality of audience clusters (e.g., audience clusters 310, 312, and 314) and a plurality of item data record clusters (e.g., item data record clusters 302, 304, 306 and 308). The bidding value table 300 is generated by the bidding module 208. In generating the bidding value table 300, the bidding module 208 receives a plurality of item data record clusters and audience clusters and assigns each cluster to the bidding value table 300. The item data record clusters 302, 304, 306 and 308 and audience clusters 310, 312, and 314 may be assigned in a manner such that each audience cluster forms a distinct combination with each item data record (e.g., bidding units 316). Bidding values for the bidding units 316 are generated based on data related to the respective item data record clusters and audience clusters that make up each combination (e.g., bidding units 316). The bidding value for a particular item data record cluster may change for each combination of that item data record cluster and respective audience clusters (e.g., bidding units 318). For example, if a plurality of user identifiers have used the same internet keyword search term to search for an item data record, the bidding value created for a single keyword search term may vary depending on the audience cluster each user identifier belongs to.

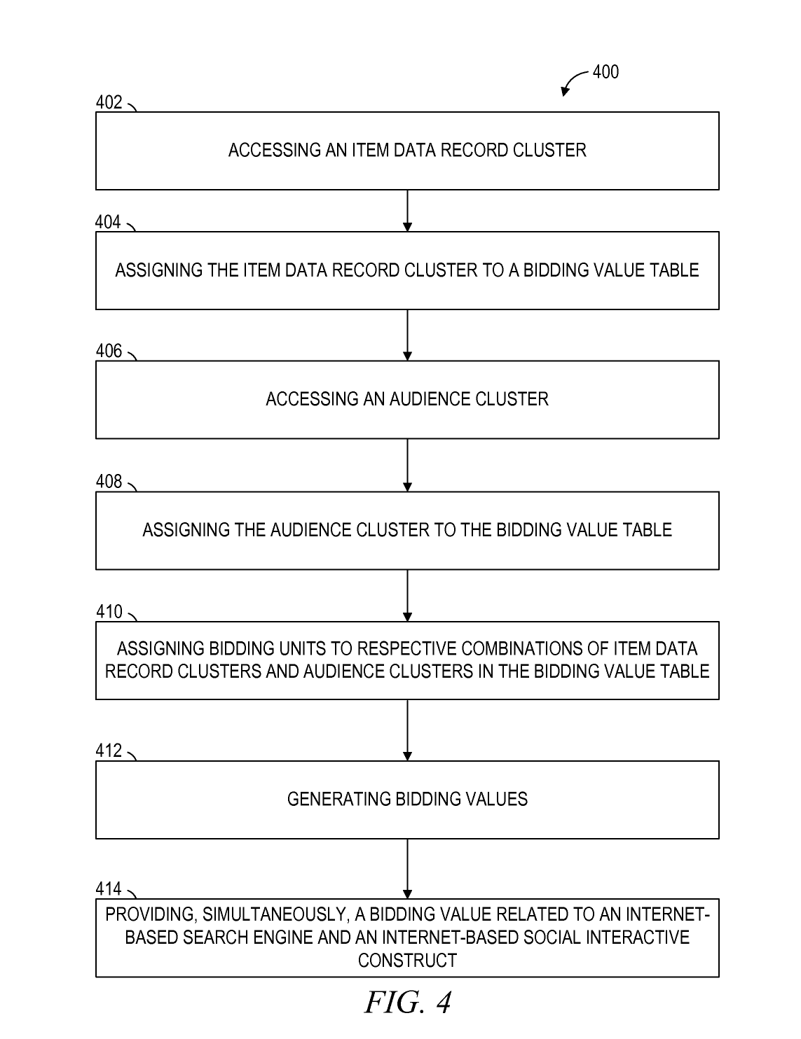

FIG. 4 is a flowchart illustrating operations of a device in performing a method 400 for generating bidding values, according to one embodiment. The UCAMP 124 may perform operations of the method 400, using the modules described above with respect to FIG. 2, using one or more processors (e.g., microprocessors or other hardware processors), or using any suitable combination thereof.

At operation 402, the bidding module 208 accesses an item data record cluster (e.g., from the database 122) generated by the item data record clustering module 204. The item data record cluster is a data object that includes a plurality of item data records that have at least one common attribute. For example, each item data record within the cluster may share the same click value score or may all have a click value score within a specified range (e.g., $0.25-$0.30 per click).

In generating the item data record cluster, the item data record selection module 202 may receive an item data record and determine whether to select the item data record for an advertising bid to advertise on an advertisement channel (e.g., a search engine advertisement channel or a social advertisement channel). The item data record selection module 202 selects the item data record based on its click value score. The item data record clustering module 204 accepts an item data record and places the item data record into an item data record cluster according to certain values (e.g., according to an item data record's click value score).

At operation 404, the bidding module 208 assigns the item data record cluster to the bidding value table 300. The bidding module 208 may assign the item data record cluster to the bidding value table 300 in a manner such that when audience clusters are present in the bidding value table 300, each item data record cluster forms a distinct combination with each audience cluster (e.g., bidding units 316). The bidding module 208 may also assign the item data record cluster to the bidding value table 300 in a manner such that when audience clusters are present in the bidding value table 300, the combination of any one item data record cluster with each audience cluster results in a different bidding value (e.g., bidding units 318).

At operation 406, the bidding module 208 accesses an audience cluster (e.g., from the database 122) generated by the audience clustering module 206. The audience cluster is a data object that includes a plurality of user identifiers that have at least on common attribute. In generating the audience cluster, the audience clustering module 206 receives a user identifier and assigns the user identifier to an audience cluster depending on certain user identifier properties (e.g., keywords used to search for an item data record, geographical location, and language). The UCAMP 124 may use a cookie sync system to place a third party cookie on a user device that identifies the user identifier's assigned audience cluster information as a parameter. The UCAMP 124 may also assign a user identifier to a particular audience cluster based on the mapping of the user identifier to an item data record.

At operation 408, the bidding module 208 assigns the audience cluster to a bidding value table 300. The bidding module 208 may assign the audience cluster to the bidding value table 300 in a manner such that when item data record clusters are present in the bidding value table 300, each audience cluster forms a distinct combination with each item data record cluster (e.g., bidding units 316). The bidding module 208 may also assign the audience cluster to the bidding value table 300 in a manner such that when item data record clusters are present in the bidding value table 300, the combination of any one audience cluster with each item data record cluster results in a different bidding value.

At operation 410, the bidding module 208 assigns bidding units to respective combinations of item data record clusters and audience clusters in the bidding value table 300. The bidding module 208 includes or accesses a database that holds values for the bidding value table 300. The bidding module 208 assigns to each bidding unit 316 within the bidding table 300, a respective combination of at least one item data record cluster and at least one audience cluster. The combinations making up the bidding units 316 may occupy cells of a database table within the bidding module 208. Any one bidding unit 316 within the bidding value table 300 may be unique from all other bidding units 316.

At operation 412, the bidding module 208 generates bidding values for respective bidding units 316, which include an amount of value to be paid for an advertisement opportunity for each of the bidding units 316. The bidding module 208 creates a bidding value based on any one bidding unit 316. The bidding module 208 may create a bidding value, including the amount of value that is to be paid for an advertising opportunity for a particular combination of item data record clusters and audience clusters, using information such as a click value score, keywords used to search for an item data record, geographical location, and language. The bidding value for a particular item data record cluster may change for each combination of the item data record clusters and the audience clusters (e.g., bidding units 318). The UCAMP 124 may provide the bidding value to one or more advertising platforms (e.g., one or more social advertisement platforms, search engine advertisement platforms, or other advertisement platforms), in any combination. For example, the UCAMP 124 may provide, simultaneously, a bidding value related to an internet-based search engine and an internet-based social interactive construct (e.g., at operation 414). Additionally, the UCAMP 124 may adjust the bidding value of any one bidding unit 316 based on received performance data of a previously generated advertisement for the bidding unit.

According to various example embodiments, one or more of the methodologies described herein may facilitate unified cross-channel advertisement. When these effects are considered in aggregate, one or more of the methodologies described herein may obviate a need for certain efforts or resources that otherwise would be involved in facilitating unified cross-channel advertisement. Efforts expended by a user in facilitating unified cross-channel advertisement may be reduced by use of (e.g., reliance upon) a special-purpose machine that implements one or more of the methodologies described herein. Computing resources used by one or more systems or machines (e.g., within the network environment 100) may similarly be reduced (e.g., compared to systems or machines that lack the structures discussed herein or are otherwise unable to perform the functions discussed herein). Examples of such computing resources include processor cycles, network traffic, computational capacity, main memory usage, graphics rendering capacity, graphics memory usage, data storage capacity, power consumption, and cooling capacity.

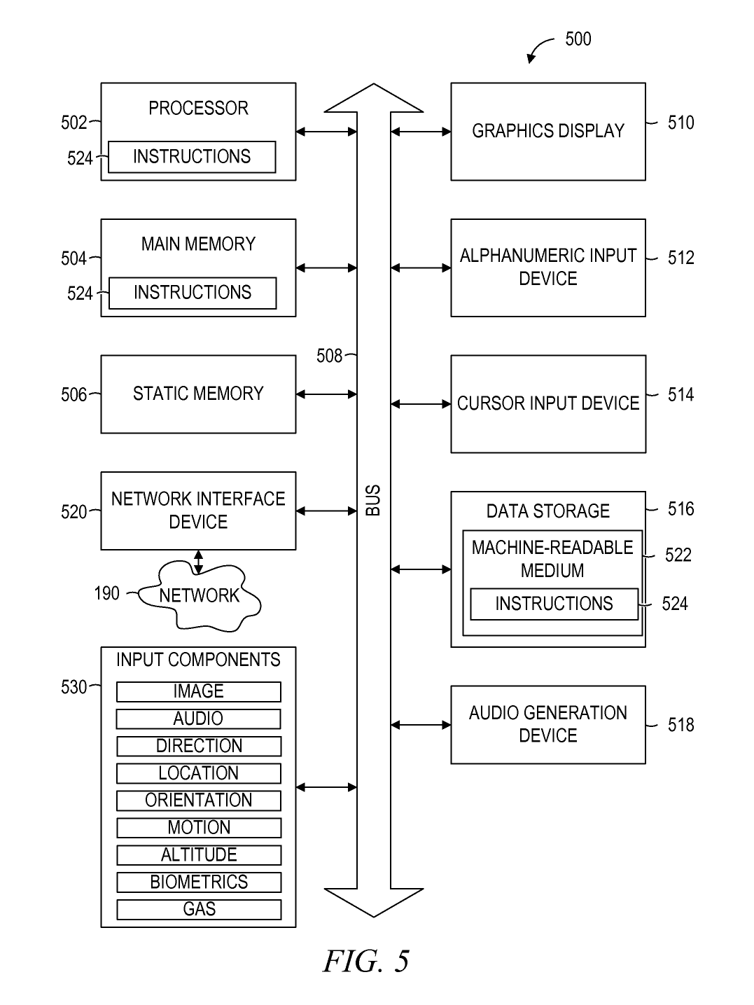

FIG. 5 is a block diagram illustrating components of a machine 500, according to some example embodiments, able to read instructions 524 from a machine-readable medium 522 (e.g., a non-transitory machine-readable medium, a machine-readable storage medium, a computer-readable storage medium, or any suitable combination thereof) and perform any one or more of the methodologies discussed herein, in whole or in part. Specifically, FIG. 5 shows the machine 500 in the example form of a computer system (e.g., a computer) within which the instructions 524 (e.g., software, a program, an application, an applet, an app, or other executable code) for causing the machine 500 to perform any one or more of the methodologies discussed herein may be executed, in whole or in part.

In alternative embodiments, the machine 500 operates as a standalone device or may be communicatively coupled (e.g., networked) to other machines. In a networked deployment, the machine 500 may operate in the capacity of a server machine or a client machine in a server-client network environment, or as a peer machine in a distributed (e.g., peer-to-peer) network environment. The machine 500 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 524, sequentially or otherwise, that specify actions to be taken by that machine. Further, while only a single machine 500 is illustrated, the term “machine” shall also be taken to include any collection of machines that individually or jointly execute the instructions 524 to perform all or part of any one or more of the methodologies discussed herein.

The machine 500 includes a processor 502 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 504, and a static memory 506, which are configured to communicate with each other via a bus 508. The processor 502 contains solid-state digital microcircuits (e.g., electronic, optical, or both) that are configurable, temporarily or permanently, by some or all of the instructions 524 such that the processor 502 is configurable to perform any one or more of the methodologies described herein, in whole or in part. For example, a set of one or more microcircuits of the processor 502 may be configurable to execute one or more modules (e.g., software modules) described herein. In some example embodiments, the processor 502 is a multicore CPU (e.g., a dual-core CPU, a quad-core CPU, or a 128-core CPU) within which each of multiple cores behaves as a separate processor that is able to perform any one or more of the methodologies discussed herein, in whole or in part. Although the beneficial effects described herein may be provided by the machine 500 with at least the processor 502, these same beneficial effects may be provided by a different kind of machine that contains no processors (e.g., a purely mechanical system, a purely hydraulic system, or a hybrid mechanical-hydraulic system), if such a processor-less machine is configured to perform one or more of the methodologies described herein.

The machine 500 may further include a graphics display 510 (e.g., a plasma display panel (PDP), a light emitting diode (LED) display, a liquid crystal display (LCD), a projector, a cathode ray tube (CRT), or any other display capable of displaying graphics or video). The machine 500 may also include an alphanumeric input device 512 (e.g., a keyboard or keypad), a cursor input device 514 (e.g., a mouse, a touchpad, a trackball, a joystick, a motion sensor, an eye tracking device, or other pointing instrument), a data storage 516, an audio generation device 518 (e.g., a sound card, an amplifier, a speaker, a headphone jack, or any suitable combination thereof), and a network interface device 520.

The data storage 516 (e.g., a data storage device) includes the machine-readable medium 522 (e.g., a tangible and non-transitory machine-readable storage medium) on which are stored the instructions 524 embodying any one or more of the methodologies or functions described herein. The instructions 524 may also reside, completely or at least partially, within the main memory 504, within the processor 502 (e.g., within the processor's cache memory), or both, before or during execution thereof by the machine 500. Accordingly, the main memory 504 and the processor 502 may be considered machine-readable media (e.g., tangible and non-transitory machine-readable media). The instructions 524 may be transmitted or received over the network 190 via the network interface device 520. For example, the network interface device 520 may communicate the instructions 524 using any one or more transfer protocols (e.g., hypertext transfer protocol (HTTP)).

In some example embodiments, the machine 500 may be a portable computing device (e.g., a smart phone, tablet computer, or a wearable device), and have one or more additional input components 530 (e.g., sensors or gauges). Examples of such input components 530 include an image input component (e.g., one or more cameras), an audio input component (e.g., one or more microphones), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), a biometric input component (e.g., a heartrate detector or a blood pressure detector), and a gas detection component (e.g., a gas sensor). Input data gathered by any one or more of these input components 530 may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 522 is shown in an example embodiment to be a single medium, the term “machine-readable medium” should be taken to include a single medium or multiple media (e.g., a centralized or distributed database, or associated caches and servers) able to store instructions 524. The term “machine-readable medium” shall also be taken to include any medium, or combination of multiple media, that is capable of storing the instructions 524 for execution by the machine 500, such that the instructions 524, when executed by one or more processors of the machine 500 (e.g., processor 502), cause the machine 500 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible and non-transitory data repositories (e.g., data volumes) in the example form of a solid-state memory chip, an optical disc, a magnetic disc, or any suitable combination thereof. A “non-transitory” machine-readable medium, as used herein, specifically does not include propagating signals per se. In some example embodiments, the instructions 524 for execution by the machine 500 may be communicated by a carrier medium. Examples of such a carrier medium include a storage medium (e.g., a non-transitory machine-readable storage medium, such as a solid-state memory, being physically moved from one place to another place) and a transient medium (e.g., a propagating signal that communicates the instructions 524).

Certain example embodiments are described herein as including modules. Modules may constitute software modules (e.g., code stored or otherwise embodied in a machine-readable medium or in a transmission medium), hardware modules, or any suitable combination thereof. A “hardware module” is a tangible (e.g., non-transitory) physical component (e.g., a set of one or more processors) capable of performing certain operations and may be configured or arranged in a certain physical manner. In various example embodiments, one or more computer systems or one or more hardware modules thereof may be configured by software (e.g., an application or portion thereof) as a hardware module that operates to perform operations described herein for that module.

In some example embodiments, a hardware module may be implemented mechanically, electronically, hydraulically, or any suitable combination thereof. For example, a hardware module may include dedicated circuitry or logic that is permanently configured to perform certain operations. A hardware module may be or include a special-purpose processor, such as a field programmable gate array (FPGA) or an ASIC. A hardware module may also include programmable logic or circuitry that is temporarily configured by software to perform certain operations. As an example, a hardware module may include software encompassed within a CPU or other programmable processor. It will be appreciated that the decision to implement a hardware module mechanically, hydraulically, in dedicated and permanently configured circuitry, or in temporarily configured circuitry (e.g., configured by software) may be driven by cost and time considerations.

Accordingly, the phrase “hardware module” should be understood to encompass a tangible entity that may be physically constructed, permanently configured (e.g., hardwired), or temporarily configured (e.g., programmed) to operate in a certain manner or to perform certain operations described herein. Furthermore, as used herein, the phrase “hardware-implemented module” refers to a hardware module. Considering example embodiments in which hardware modules are temporarily configured (e.g., programmed), each of the hardware modules need not be configured or instantiated at any one instance in time. For example, where a hardware module includes a CPU configured by software to become a special-purpose processor, the CPU may be configured as respectively different special-purpose processors (e.g., each included in a different hardware module) at different times. Software (e.g., a software module) may accordingly configure one or more processors, for example, to become or otherwise constitute a particular hardware module at one instance of time and to become or otherwise constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory (e.g., a memory device) to which it is communicatively coupled. A further hardware module may then, at a later time, access the memory to retrieve and process the stored output. Hardware modules may also initiate communications with input or output devices, and can operate on a resource (e.g., a collection of information from a computing resource).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module in which the hardware includes one or more processors. Accordingly, the operations described herein may be at least partially processor-implemented, hardware-implemented, or both, since a processor is an example of hardware, and at least some operations within any one or more of the methods discussed herein may be performed by one or more processor-implemented modules, hardware-implemented modules, or any suitable combination thereof.

Moreover, such one or more processors may perform operations in a “cloud computing” environment or as a service (e.g., within a “software as a service” (SaaS) implementation). For example, at least some operations within any one or more of the methods discussed herein may be performed by a group of computers (e.g., as examples of machines that include processors), with these operations being accessible via a network (e.g., the Internet) and via one or more appropriate interfaces (e.g., an application program interface (API)). The performance of certain operations may be distributed among the one or more processors, whether residing only within a single machine or deployed across a number of machines. In some example embodiments, the one or more processors or hardware modules (e.g., processor-implemented modules) may be located in a single geographic location (e.g., within a home environment, an office environment, or a server farm). In other example embodiments, the one or more processors or hardware modules may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and their functionality presented as separate components and functions in example configurations may be implemented as a combined structure or component with combined functions. Similarly, structures and functionality presented as a single component may be implemented as separate components and functions. These and other variations, modifications, additions, and improvements fall within the scope of the subject matter herein.

Some portions of the subject matter discussed herein may be presented in terms of algorithms or symbolic representations of operations on data stored as bits or binary digital signals within a memory (e.g., a computer memory or other machine memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “accessing,” “processing,” “detecting,” “computing,” “calculating,” “determining,” “generating,” “presenting,” “displaying,” or the like refer to actions or processes performable by a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
by one or more processors of a machine, accessing an item data record cluster, the item data record cluster including a plurality of item data records having at least one common attribute;
assigning the item data record cluster to a bidding value table;
accessing an audience cluster, the audience cluster including a plurality of user identifiers having at least one common attribute;
assigning the audience cluster to the bidding value table;
assigning a bidding unit to a combination of the item data record cluster and the audience cluster, the combination of the item data record cluster and the audience cluster being among a plurality of combinations of item data record clusters and audience clusters in the bidding value table; and
generating a bidding value for the bidding unit, the bidding value including an amount of value to be paid for an advertisement opportunity for the bidding unit.

2. The method of claim 1, wherein a bidding value for a bidding unit changes for each combination of an item data record cluster from among a plurality of item data record clusters and an audience cluster from among a plurality of audience clusters.

3. The method of claim 1, wherein a bidding value is generated based on data determined from an internet keyword search term.

4. The method of claim 1, wherein a bidding value is generated based on data determined from an interaction of a user identifier and an item data record.

5. The method of claim 1, wherein a bidding value is generated based on data determined from an internet-based social interactive construct.

6. The method of claim 1, further including adjusting a bidding value of a bidding unit based on received performance data of a previously generated advertisement for the bidding unit.

7. The method of claim 1, further comprising providing, simultaneously, a bidding value related to an internet-based search engine and an internet-based social interactive construct.

8. A system comprising:
at least one processor of a machine;
a machine-readable storage medium embodying instructions that, when executed by the at least one processor of the machine, cause the machine to perform operations comprising:
accessing an item data record cluster, the item data record cluster including a plurality of item data records having at least one common attribute;
assigning the item data record cluster to a bidding value table;
accessing an audience cluster, the audience cluster including a plurality of user identifiers having at least one common attribute;
assigning the audience cluster to the bidding value table;
assigning a bidding unit to a combination of the item data record cluster and the audience cluster, the combination of the item data record cluster and the audience cluster being among a plurality of combinations of item data record clusters and audience clusters in the bidding value table; and
generating a bidding value for the bidding unit, the bidding value including an amount of value to be paid for an advertisement opportunity for the bidding unit.

9. The method of claim 8, wherein a bidding value for a bidding unit changes for each combination of an item data record cluster from among a plurality of item data record clusters and an audience cluster from among a plurality of audience clusters.

10. The method of claim 8, wherein a bidding value is generated based on data determined from an internet keyword search term.

11. The method of claim 8, wherein a bidding value is generated based on data determined from an interaction of a user identifier and an item data record.

12. The method of claim 8, wherein a bidding value is generated based on data determined from an internet-based social interactive construct.

13. The method of claim 8, wherein the operations further comprise adjusting a bidding value of a bidding unit based on received performance data of a previously generated advertisement for the bidding unit.

14. The method of claim 8, wherein the operations further comprise providing, simultaneously, a bidding value related to an internet-based search engine and an internet-based social interactive construct.

15. A non-transitory machine-readable storage medium embodying instructions that, when executed by one or more processors of a machine, cause the machine to perform operations comprising:
accessing an item data record cluster, the item data record cluster including a plurality of item data records having at least one common attribute;
assigning the item data record cluster to a bidding value table;
accessing an audience cluster, the audience cluster including a plurality of user identifiers having at least one common attribute;
assigning the audience cluster to the bidding value table;
assigning a bidding unit to a combination of the item data record cluster and the audience cluster, the combination of the item data record cluster and the audience cluster being among a plurality of combinations of item data record clusters and audience clusters in the bidding value table; and
generating a bidding value for the bidding unit, the bidding value including an amount of value to be paid for an advertisement opportunity for the bidding unit.

16. The non-transitory machine-readable storage medium of claim 15, wherein a bidding value for a bidding unit changes for each combination of an item data record cluster from among a plurality of item data record clusters and an audience cluster from among a plurality of audience clusters.

17. The method of claim 15, wherein a bidding value is generated based on data determined from an interaction of a user identifier and an item data record.

18. The method of claim 15, wherein a bidding value is generated based on data determined from an internet-based social interactive construct.

19. The method of claim 15, wherein the operations further comprise adjusting a bidding value of a bidding unit based on received performance data of a previously generated advertisement for the bidding unit.

20. The method of claim 15, wherein the operations further comprise providing, simultaneously, a bidding value related to an internet-based search engine and an internet-based social interactive construct.
